(19) United States
(12) Patent Application Publication
(10) Pub. No.: US 2006/0293766 A1
(43) Pub. Date: Dec. 28, 2006

(54) Compensation method for time delays in oscillatory control

(76) Inventors: Michael Schneider, Bloomfield Twp, MI (US); Dale Crombez, Livonia, MI (US)

Correspondence Address: TUNG & ASSOCIATES, 838 WEST LONG LAKE, SUITE 120, BLOOMFIELD HILLS, MI, 48302, US

(21) Appl. No.: 11/165,813

(22) Filed: Jun. 24, 2005

(51) Int. Cl. G05B 11/01; G05B 13/02

(52) U.S. Cl. 700/72; 700/71; 700/33; 700/14

(57) ABSTRACT

A system and method that compensates for the time delay between a sensed oscillatory signal and an oscillatory input control signal TCᵢₙ are provided. Initially, an oscillation signal is detected and/or a need for time delay compensation is determined. An algorithm is performed on the TCᵢₙ to provide an actuator output signal, TCₒᵤₜ. In a preferred embodiment when TCᵢₙ has peaked and has begun to be reduced from the peak by a delta amount, the actuator output TCₒᵤₜ is commanded immediately to a central value of the oscillation. In another preferred embodiment, when the control signal TCᵢₙ has peaked and has begun to be reduced from the peak by a delta amount, the actuator output TCₒᵤₜ is commanded immediately to an alternate value with an offset large enough to drive the TCₒᵤₜ past the central value of the oscillation and toward an opposite peak.

### FIELD OF THE INVENTION

The present invention generally relates to oscillatory control technology and more particularly, relates to an oscillatory control system and method for compensating for time delays and for dampening unwanted oscillation signals in a control system.

### BACKGROUND OF THE INVENTION

In the case of motor torque being used to damp out mechanical oscillations, the phase relationship between the control action of an actuator, the motor torque, and the mechanical deflection or unwanted oscillatory signal that is being damped out is important for the damping action to be effective.

Motor control and active motor damping strategies are often used in automobiles and other vehicles powered by electric motors or vehicles having a hybrid ICE electric motor power configuration, typically called Hybrid Electric Vehicles (HEVs).

HEV configurations may include a series hybrid electric vehicle (SHEV) configuration is a vehicle with an engine (most typically an ICE) connected to an electric motor called a generator. The generator, in turn, provides electricity to a battery and another motor, called a traction motor. In the SHEV, the traction motor is the sole source of wheel torque. There is no mechanical connection between the engine and the drive wheels. A parallel hybrid electrical vehicle (PHEV) configuration has an engine (most typically an ICE) and an electric motor that work together in varying degrees to provide the necessary wheel torque to drive the vehicle. Additionally, in the PHEV configuration, the motor can be used as a generator to charge the battery from the power produced by the ICE.

For example in a driveline having a drive motor, such as a traction control motor in an HEV. The drive motor during normal drive and braking operations exerts a torque on the drivetrain to drive the wheels and unwanted oscillations in the driveline can occur due to motor inertia.

Control systems that use methods such as derivative control are often used in torque control strategies to provide a desired amount of torque generated by a motor to a mechanical system, such as a driveline in a vehicle having wheels driven by the motor.

Typically, as shown in prior art FIG. 1, an unwanted oscillatory signal may be detected using a control system. The oscillatory signal shown is illustrated as a sinusoidal signal having a repeating period, and uniform amplitudes, however, an actual oscillatory signal may vary from the signal shown in FIG. 1. A control signal (TCin as shown in prior art FIG. 2) is then calculated and output to dampen the oscillatory signal. To effectively dampen the unwanted oscillatory signal, TCin is an oscillation signal having a time delay t, as shown in FIG. 1, or a phase error that exists between the sensed oscillation signal and TCin.

Additionally, existing control systems often have time delays associated with sensing, computation, and actuation, however, time delays often reduce the effectiveness of the system by increasing the phase lag of the controlled output. There are techniques for compensating for time delays such as the use of derivative control, but these methods are sometimes either infeasible or insufficient.

It is common for vehicle traction motor controllers to include some sort of torque oscillation control feature in a motor torque control strategy.

Existing torque control methods may operate to eliminate vibrations in the driveline by controlling a flux producing current to the motor. Such a system is disclosed in U.S. Pat. No. 6,429,610B1 issued to Russell (RUSSELL). RUSSELL uses a flux producing current that is proportional to the speed of the motor to compensate for excessive motor vibration.

U.S. Pat. No. 6,002,232 issued to McConnell et. al. discloses various Robust Vibration Suppression methods and systems that use a control system to improve system performance in robustness, noise or speed as desired by a user. However, the McConnell reference does not compensate for phase errors or time delays between an unwanted oscillatory sign and an output control signal.

Many control systems, such as U.S. Pat. No. 5,304,907 issued to Abe et al. (ABE) provide a controller to maintain a required phase relationship between an actuator output, such as a servo motor system, and an unwanted oscillating signal. However, such systems, like the ABE invention require complex equipment and circuitry.

Therefore it is desirable to provide a simple control system that compensates for time delays in a controller using a modified input control signal to improve the effectiveness of the input control signal to reduce both time lag and phase errors and thus, efficiently control the oscillatory signal.

### SUMMARY OF THE INVENTION

The present invention provides an oscillatory control system and method for compensating for time delays associated with oscillatory signals in a control system. Oscillations are defined herein as a cyclic signal.

Generally, the oscillatory control system provides:
an oscillatory signal-generating device;
a sensor that senses an oscillatory signal generated by the oscillatory signal-generating device and transmits a sensed input signal TCᵢₙ to a computational device;
a computational device capable of performing oscillatory compensation algorithms in accordance with the present invention; and
an actuator that is actuated by a TCₒᵤₜ command signal that operates to achieve the control objectives. An object might be to dampen the unwanted oscillatory control signal.

In general, a general oscillatory control method for compensating for time delays in oscillatory signals detected in a control system is provided. Preferably, the present invention may dampen unwanted oscillatory signals, the general oscillatory control method has the steps of:
providing an input control signal having a value that ranges between at least one maximum peak and at least one minimum peak, the input control signal being oscillatory and related to a corresponding controlled oscillatory signal; and
providing an output signal substantially similar to the input control signal to input into an actuator, wherein the output signal compensates for time delays present in a control system.

Additional steps are provided to the general method of the present invention in a first preferred embodiment. The first preferred embodiment additionally provides the steps of:
commanding the output signal to a central or average value of the oscillating input control signal when the input control signal drops below the at least one maximum peak value by a delta amount; and
commanding the output signal to the central or average value of the oscillating input control signal when the input control signal rises above the minimum peak value of the input control signal by a delta amount.

Alternatively, alternative additional steps are provided to the general method of the present invention in a second preferred embodiment. The second oscillatory control method for compensating for time delays in an oscillatory control system is provided, the second oscillatory control method has the steps of:
offsetting the output signal when the input control signal value drops below the at least one positive maximum peak value by a delta amount until the input control signal becomes less than a central value of an oscillation (CV), and the slope becomes positive; and
offsetting the output signal when the input control signal rises above the at least one minimum peak value by a delta amount until the input control signal becomes greater than a central value of the oscillation, and the slope of the input control signal becomes negative, wherein the central value of the oscillation is the average value of the input control signal oscillation.

### BRIEF DESCRIPTION OF THE DRAWINGS

These and other objects, features and advantages of the present invention will become apparent from the following detailed description and the appended drawings in which:

FIG. 1 is a prior art graphical illustration of an unwanted oscillatory signal.

FIG. 2 is a graphical illustration of prior art control signal used to dampen an unwanted oscillatory signal.

FIG. 3 is an oscillatory control system of the present invention.

FIG. 4 is a flowchart depicting a method in accordance with a preferred embodiment of the present invention.

FIG. 5 is a flowchart further describing the method steps shown in FIG. 4.

FIG. 6 is a graphical illustration of a TCₒᵤₜ signal generated using the method shown in FIGS. 4-5.

FIG. 7 is a flowchart depicting a method in accordance with a preferred embodiment of the present invention.

FIG. 8 is a flowchart further describing the method steps shown in FIG. 7.

FIG. 9 is a graphical illustration of a TCₒᵤₜ signal generated using the method shown in FIGS. 7-8.

### DETAILED DESCRIPTION OF THE PREFERRED EMBODIMENTS

The present invention provides an oscillatory control system and method for compensating for time delays and for dampening unwanted oscillation signals in a control system.

The present invention may be used to compensate for time delays and phase lags in an oscillatory control system. The present invention may be used in a system intended to eliminate unwanted oscillations in a system having a motor that generates torque as well as unwanted oscillations within a mechanical system. For example, the oscillatory control method of the present invention may be used in a system intended to actively damp unwanted driveline oscillations in any type of motor vehicle including HEVs. Additional applications for the present invention may also include, but not should not be limited to, suspension systems, electronic steering systems, and servo control mechanisms.

Referring now to the drawings, as shown in FIG. 3, the present invention provides an oscillatory control system 20 used to compensate for time delays and phase lags in an oscillatory control system. The oscillatory control system 20 provides an oscillatory signal generating device 22, a sensor 26 that senses an oscillatory signal 24 generated by the oscillatory signal generating device 22 and transmits a sensed input control signal TCᵢₙ 28 to a computational device, a computational device 30 capable of performing oscillatory compensation algorithms in accordance with the present invention, and an actuator 34 that is actuated by an output signal TCₒᵤₜ 32 that operates to dampen the unwanted oscillatory control signal 24. Preferably, the computational device is a conventional computer having a CPU that processes arithmetic algorithms in accordance with a predefined set of instructions of the present invention.

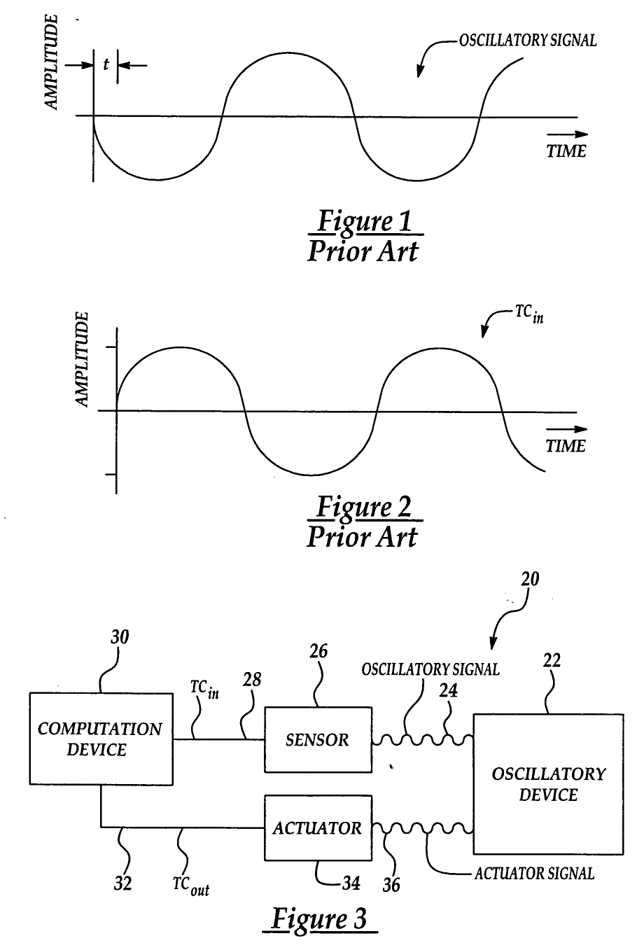

As shown in prior art FIGS. 1-2, a time delay t, or phase lag exists between the actual oscillation signal 24 and the detected oscillation torque command signal or input control signal (TCᵢₙ). Thus, the TCᵢₙ signal 28 shown in FIGS. 2 and 3 that is a delayed oscillation signal cannot operate to entirely eliminate the original sensed oscillation signal 24. The more out of phase due to a time lag that the TCᵢₙ signal 28 is with the oscillation signal, the less the oscillation signal is dampened. Preferably, the unwanted oscillatory signal is sinusoidal, however the oscillatory signal may be any repetitive oscillatory signal that may vary in amplitude and period from the signal shown in FIG. 1.

The present invention operates to compensate for the time delay allowing the control system to effectively dampen the unwanted oscillation signal by providing an output signal TCₒᵤₜ 32 that is an enhanced and modified TCᵢₙ signal 28.

In general, the present invention provides for detection of an oscillatory signal, or detection of conditions that may cause an oscillatory signal to arise and provides a corresponding input control signal that has a value that ranges between at least one maximum peak and at least one minimum peak. The input control signal is oscillatory and related to a corresponding oscillatory signal.

An output signal that is substantially similar to the input control signal is provided to input into an actuator and thus, to compensate for time delays and phase lags in the input control signal.

In a preferred embodiment of the method of the present invention, the output signal is commanded to the value about which the oscillation of the input control signal is centered, the central value (CV), when the input control signal value drops below a delta amount of the at least one maximum peak value. Next, the output signal is set equal to the central value until the input control signal becomes less than the central value. Once the input control signal becomes less than the central value, the output signal is set equal to the input control signal.

Additionally, the output signal is commanded to the central value when the input control signal rises above a delta amount of the at least one minimum peak. Next, the output signal is set equal to the central value until the input control signal becomes greater than the central value. Once the input control signal becomes greater than the central value, the output signal is set equal to the input control signal.

If the input control signal has not dropped below a delta amount of the at least one maximum peak, then the output signal is set equal to the input control signal.

Alternatively, if the input control signal has not risen above a delta amount of the at least one minimum peak, then the output signal is set equal to the input control signal.

In an alternate preferred embodiment of the method of the present invention, the output signal is offset when the input control signal drops a delta amount below the at least one maximum peak until the input control signal becomes less than the central value of the oscillation and the slope of the input control signal becomes positive. Once the input control signal becomes less than the central value and the slope of the input control signal becomes positive, the output signal is set equal to the input control signal.

Alternatively, the output signal is offset when the input control signal rises by a delta amount above the at least one minimum peak until the input control signal becomes greater than the central value and the slope of the input control signal becomes negative. Once the input control signal becomes greater than the central value and the slope of the input control signal becomes negative, the output signal is set equal to the input control signal.

Preferably, the output signal is offset by an offset value large enough to drive the output signal past the central value of the oscillation and toward the opposite peak.

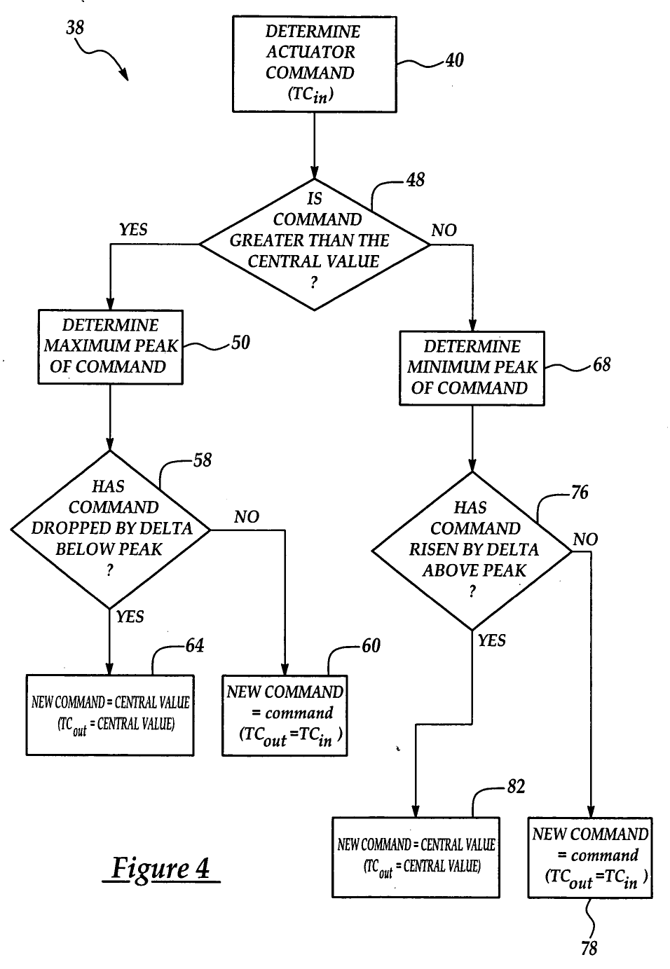

In one preferred embodiment, as shown in FIGS. 4-6, when the input control signal, TCᵢₙ has peaked to equal at least one of a maximum peak value having an associated peak value (TCₚₑₐₖ greater than the central value) and a minimum peak value having an associated peak value (TCₚₑₐₖ less than the central value)and has begun to vary from the at least one maximum or minimum peak value TCₚₑₐₖ by a threshold amount (Δ), the output signal TCₒᵤₜ is commanded immediately to the central value. The threshold amount A is equal to a fractional value of the amplitude.

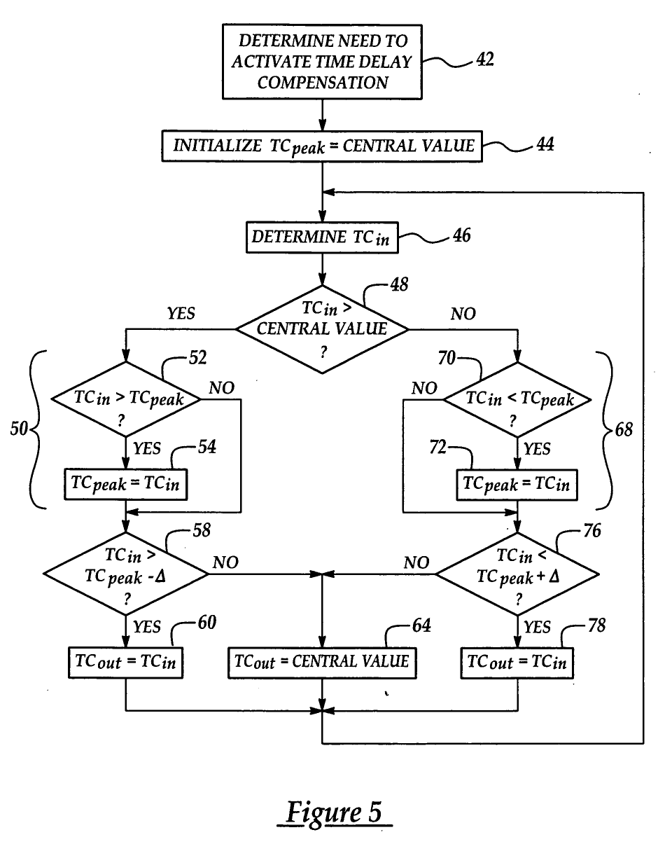

As shown in FIGS. 4-5, a preferred embodiment of a compensation method 38 of the present invention is provided. The method 38 has the following steps:
providing an input control signal TCᵢₙ having an associated maximum peak value when TCᵢₙ has a value greater than the central value and an associated minimum peak value when TCᵢₙ has a value less than the central value in response to a corresponding unwanted oscillatory signal; and
providing a TCₒᵤₜ signal associated with the TCᵢₙ signal to input into an actuator to dampen the corresponding unwanted oscillatory signal.

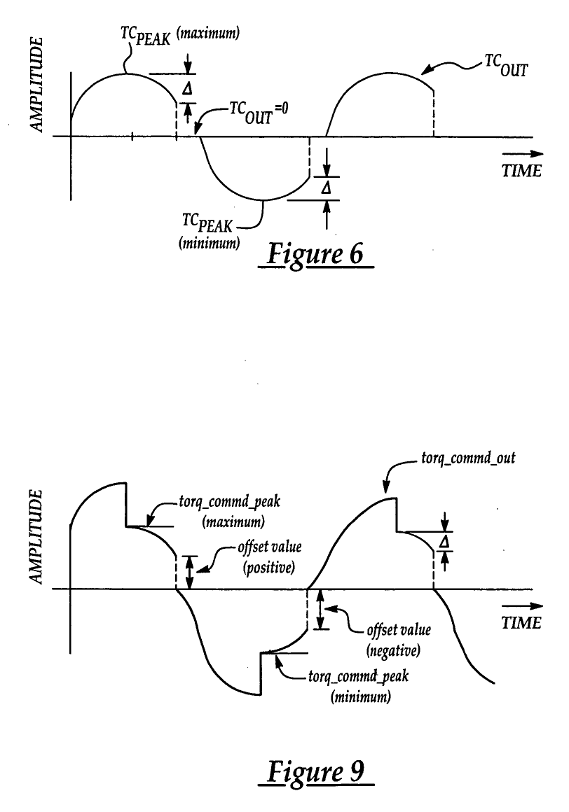

More particularly, FIG. 4 is a flowchart showing an overview of the compensation method 38, and FIG. 5 is a flowchart illustrating a more detailed description of the method shown in FIG. 4. As shown in FIGS. 4-5, and in the graph illustrating TCₒᵤₜ in FIG. 6, the TCₒᵤₜ signal 32 is similar to the TCᵢₙ signal 28, however, the TCₒᵤₜ signal is commanded to the central value when the TCᵢₙ drops below (for a signal above the central value) or above (for a signal below the central value) a threshold representing a change in the TCᵢₙ signal from the peak value, TCₚₑₐₖ, toward the central value of the oscillation, wherein the peak TCᵢₙ peak value (TCₚₑₐₖ) is a sampled TCᵢₙ value previously calculated at the highest or lowest value or strength value (either a positive or a negative value) of the TCᵢₙ signal associated with a corresponding oscillation signal.

Initially, as shown in FIG. 4, an actuator command input or TCᵢₙ is determined (step 40).

More particularly, as shown in FIG. 5, step 40 has the following substeps: a) initially, a need to activate time delay compensation is detected (step 42); b) a TCₚₑₐₖ value is initialized to the central value (TCₚₑₐₖ=central value) (step 44); and c) a TCᵢₙ signal is determined (step 46).

Next, as shown in FIGS. 4-5, a determination is made of whether the TCᵢₙ signal is greater than the central value (step 48).

If TCᵢₙ is greater than the central value, then a maximum TCₚₑₐₖ value is determined (step 50). Step 50 has the substeps 52 and 54 as described below.

A determination is made whether TCᵢₙ is greater than TCₚₑₐₖ (step 52).

When TCᵢₙ is greater than the central value, if TCᵢₙ is not greater than TCₚₑₐₖ, then it is determined if TCᵢₙ is greater than TCₚₑₐₖ minus a delta amount (Δ) (delta amount shown in FIG. 6) (step 58), wherein the Δ equals a portion of the amplitude of the TCᵢₙ oscillation .

If TCᵢₙ is greater than TCₚₑₐₖ, then TCₚₑₐₖ is set equal to TCᵢₙ (step 54), and then step 58 is performed.

After performing step 58, if the TCᵢₙ is greater than TCₚₑₐₖ minus Δ, then an output signal TCₒᵤₜ is set equal to TCᵢₙ (step 60) and then steps 46, 48, 50, 58, and 60 or 64, are repeated if TCᵢₙ is greater than the central value. However, if the TCᵢₙ not greater than TCₚₑₐₖ minus Δ, then TCₒᵤₜ is set equal to the central value (step 64) and steps 46, 48, 50, 58, and 60 are repeated if TCᵢₙ is greater than the central value.

If TCᵢₙ is not greater than the central value, then a minimum TCₚₑₐₖ value is determined (step 68). Step 68 has the substeps 70 and 72 as described below.

A determination is made whether TCᵢₙ is less than TCₚₑₐₖ (step 70).

When TCin is less than the central value, if TCin is not less than TCₚₑₐₖ, then it is determined if TCin is less than TCₚₑₐₖ minus a delta amount (Δ) (delta amount shown in FIG. 6) (step 76), wherein the A equals a portion of the amplitude of the TCᵢₙ oscillation.

If TCᵢₙ is less than TCₚₑₐₖ, then TCₚₑₐₖ is set equal to TCᵢₙ (step 72), and then step 76 is performed.

After performing step 76, if the TCᵢₙ is less than TCₚₑₐₖ plus Δ, then an output signal TCₒᵤₜ is set equal to TCᵢₙ (step 78) and then steps 46, 48, 68, 76, and 78 or 82, are repeated. However, if the TCᵢₙ is not less than TCₚₑₐₖ plus Δ, then TCₒᵤₜ is set equal to the central value (step 82) and steps 46, 48, 68, 76, and 78 or 82 are repeated if TCin is less than the central value.

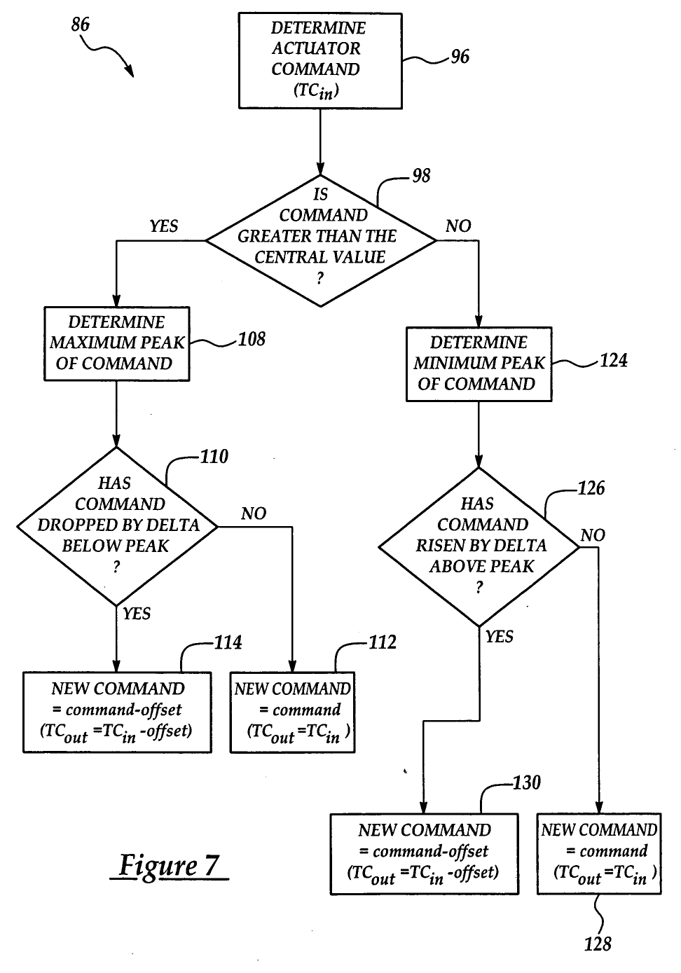

Referring now to FIGS. 7-9, in an alternative preferred embodiment, a time and phase advantage may be gained by triggering a transition of an actuator output command between values above and below the central value sooner. This is especially valuable when the responsiveness of the actuator output is limited with respect to a relatively high oscillation frequency. This compensation has been accomplished through the logic and methods described herein.

As shown in FIGS. 7-9, when the input control signal TCᵢₙ has peaked to at least one of a maximum peak value and a minimum peak value and has begun to be reduced (or increased) from the peak by a threshold amount (Δ), the actuator output TCₒᵤₜ is adjusted immediately by an offset value that could be large enough to drive the TCₒᵤₜ past the central value and toward an opposite peak.

Furthermore, as the command continues to move away from the peak value, the compensated command is correspondingly increased toward the opposite peak. This triggers the transition, at the maximum rate, from the positive to the negative peak, or vice versa, sooner than it would otherwise occur. The result is reduced controller delay and reduced phase error, thus making the control system more effective. This embodiment differs from the first embodiment by causing the control signal output or actuator command TCₒᵤₜ to go from near one peak through the central value and toward the opposite peak sooner.

As defined in this embodiment, a torque_command_in is a torque command signal before the compensation method of the present invention is applied (see prior art FIG. 1 and FIG. 3). The torque_command_in is assumed to be a signed variable.

A torque_command_out signal or value is a torque command after the compensation method in accordance with the present embodiment is applied. The torque_command_out is assumed to be a signed variable.

A torque_command_fraction is a parameter that is a positive value between 0 and 1 (0<torque_command_fraction<1).

The torq_command_peak is an internal variable that is initialized to the central value.

A method 86 of the present invention operates to compensate for the time delay by providing a torq_commd_out signal that is a modified torq_commd_in signal. The torq_commd_out signal is similar to the torq_commd_in signal, however, the torq_commd_out signal is modified by an offset when the torq_commd_in drops below a threshold value representing a change in the TCᵢₙ signal from the peak value, TCₚₑₐₖ toward the central value of the oscillation, wherein the peak torq_commd_in peak value (torq_commd_peak) is a sampled torq_commd_in value previously calculated at the highest or lowest value or strength value of the torq_commd_in signal.

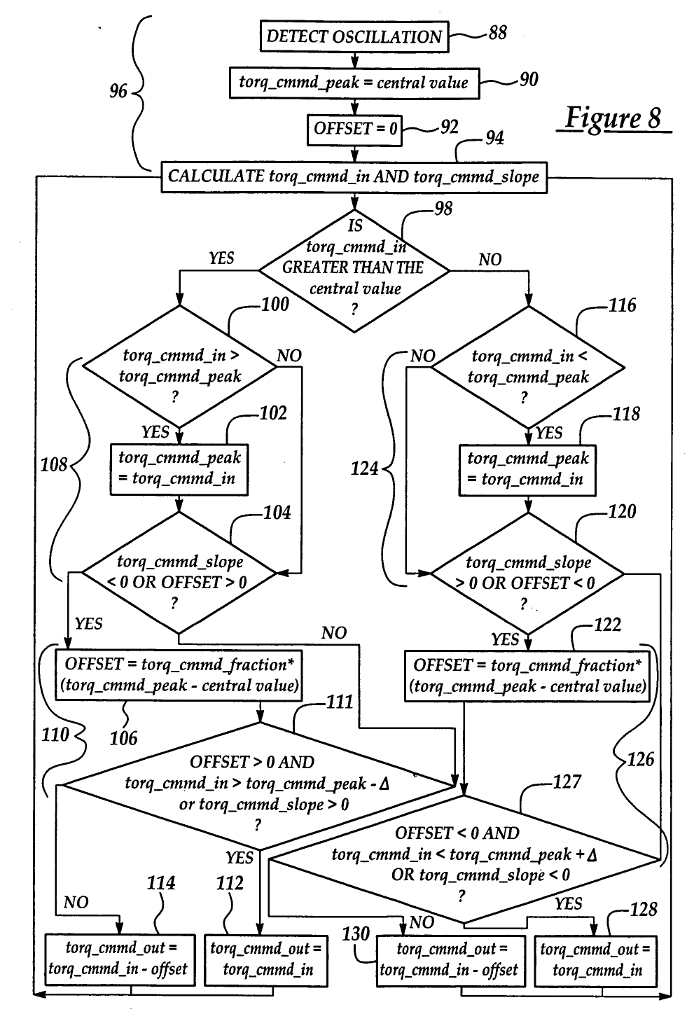

Generally, the method 86 shown in FIGS. 7-8 has the steps of:
providing a control signal torq_commd_in having an associated maximum peak value when torq_commd_in has a value greater than the central value and an associated minimum peak value when torq_commd_in has a value less than the central value in response to a corresponding controlled oscillatory signal; and
providing a torq_commd_out signal associated with the torq_commd_in signal to input into an actuator to dampen the corresponding unwanted oscillatory signal;
offsetting the torq_commd_out signal as the torq_commd_in value minus a predefined offset value when the TCᵢₙ amplitude drops below a predefined threshold determined with respect to the associated maximum peak value; and
offsetting the torq_commd_out signal by the torq_commd_in value minus an offset value when the torq_commd_in rises above a threshold determined with respect to the associated minimum peak value.

More particularly, as shown in FIG. 7, an initial actuator command control signal input or torq_commd_in is determined (step 96).

More particularly, as shown in FIG. 8, step 108 has the following substeps: a) initially, an oscillation is detected (step 88); b) then, a torq_commd_peak value, is set equal to the central value (step 90); c) an offset value is set equal to zero (step 92; and d) a torq_commd_in and a torque command slope (torq_cmmd_slope) value are determined (step 94).

Next, as shown in FIGS. 7-8, a determination is made of whether the torq_commd_in signal is a value above the central value or a value below the central value(step 98).

Next, as shown in FIG. 7, if torq_commd_in is greater than the central value, then a maximum torque command peak (Torq_commd_peak) is determined (step 108).

More particularly, as shown in FIG. 8, step 108 has the following substeps:
comparing the torq_commd_peak with torq_commd_in to determine whether torq_commd_in is greater than torq_commd_peak, wherein during a first oscillation, the torq_commd_peak was initialized to the central value, and wherein during each subsequent oscillation after the first oscillation the torq_commd_peak is equal to a last determined torq_commd_peak selected from a value of TCin (step 100);

setting torq_commd_peak equal to torq_commd_in if a current torq_commd_in calculated value at a time Tₙ is greater than the value of torq_commd_peak (step 102); and

determining if a slope (torq_commd_slope) of the torq_commd_in is less than zero (thus indicating a decreasing or negative slope) or if an offset value, indicating a fractional value of the quantity torq_commd_peak minus the central value, is greater than zero (step 104).

As shown in FIGS. 7-8, after performing step 108, a determination is made if the torq_command_in has dropped by a delta amount below the maximum torq_commd_peak (step 110).

Step 110 has a substep 106 of setting an offset value equal to a torq_commd_fraction multiplied by the quantity torq_commd_peak minus the central value if the slope (torq_commd_slope) of the torq_commd_in is less than zero (thus indicating a decreasing or negative slope) or if the offset is greater than zero (step 104).

Step 110 is performed by determining if the offset is greater than zero and if either the torq_commd_in is greater than the quantity torq_commd_peak minus a selected amount, Δ, or the torq_commd_slope is greater than zero (step 111).

Next, a torq_commd_out, as shown in FIG. 9 illustrating a graph of a torq_commd_out signal, is set equal to the torq_commd_in if the offset is greater than zero and either the torq_commd_in is greater than the quantity torq_commd_peak minus a selected amount, Δ, or the torq_commd_slope is greater than zero (step 112).

However, a torq_commd_out is set equal to the torq_commd_in minus the offset if either the offset is not greater than zero or both the torq_commd_in is not greater than the quantity torq_commd_peak minus a selected amount, A, and the torq_commd_slope is not greater than zero(step 114).

After completing step 112 or step 114, steps 94 and 98 are repeated to determine a next torq_commd_in and to repeat either steps 108, 110, 112, and 114 if the torq_commd_in is greater than the central value or steps 124, 126, 128, and 130 if torq_commd_in is less than the central value using the iterative process of the present invention.

Alternatively, as shown in FIG. 7, if torq_commd_in is less than the central value, then a minimum torque command peak (Torq_commd_peak) is determined (step 124).

More particularly, as shown in FIG. 8, step 124 has the following substeps:
comparing the torq_commd_peak with torq_commd_in to determine whether torq_commd_in is less than torq_commd_peak, wherein during a first oscillation, the torq_commd_peak is initialized to the central value, and wherein during each subsequent oscillation after the first oscillation the torq_commd_peak is equal to a last determined torq_commd_peak selected from a value of TCᵢₙ (step 116); and
setting torq_commd_peak equal to torq_commd_in if a current torq_commd_in calculated value at a time Tₙ is less than the value of torq_commd_peak (step 118); and
determining if a slope (torq_commd_slope) of the torq_commd_in is greater than zero (thus indicating an increasing or positive slope) or if an offset value, indicating a fractional value of the quantity torq_commd_peak minus the central value, is less than zero (step 120).

As shown in FIGS. 7-8, after performing step 124, a determination is made if the torq_command_in has risen by a predefined delta amount above the minimum torq_commd_peak (step 126).

Step 126 has a substep 122 of setting an offset value equal to a torq_commd_fraction multiplied by the quantity torq_commd_peak minus the central value if a slope (torq_commd_slope) of the torq_commd_in is greater than zero (thus indicating an increasing or positive slope) or if the offset is less than zero (step 120).

Step 126 is further performed by determining if both the offset is less than zero and either the torq_commd_in is less than the quantity torq_commd_peak plus a selected amount, Δ, or if the torq_commd_slope is less than zero (step 127).

Next, a torq_commd_out is set equal to the torq_commd_in if the offset is less than zero and if either the torq_commd_in is less than the quantity torq_commd_peak plus a selected amount, Δ, or the torq_commd_slope is less than zero (step 128).

However, a torq_commd_out is set equal to the torq_commd_in minus the offset if either the offset is not less than zero or both the torq_commd_in is not less than the quantity torq_commd_peak plus a selected amount, Δ, and the torq_commd_slope is not less than zero(step 130).

After completing step 128 or step 130, steps 94 and 98 are repeated to determine a next torq_commd_in and to repeat either steps 108, 110, 112, and 114 if the torq_commd_in is greater than the central value or steps 124, 126, 128, and 130 if torq_commd_in is less than the central value using the iterative process of the present invention.

From the foregoing, it should be appreciated that several embodiments of a compensation system and method for oscillatory control have been provided.

While several preferred embodiments have been presented in the foregoing detailed description, it should be understood that a vast number of variations exist and the several preferred embodiments are merely examples, and are not intended to limit the scope, applicability or configuration of the invention in any way. Rather, the foregoing detailed description provides those of ordinary skill in the art with a convenient guide for implementing preferred embodiments of the invention and various changes can be made in the function and arrangements of the exemplary embodiment without departing from the spirit and scope of the appended claims.

What is claimed is:

1. A method for compensating for time delays in a control system comprising the steps of:
providing an input control signal into a control system, the input control signal having a value that ranges between at least one maximum peak and at least one minimum peak, the input control signal being related to a corresponding oscillatory signal; and
providing an output signal from the control system substantially similar to the input control signal to input into an actuator, wherein the output signal compensates for time delays present in the control system.

2. The method of claim 1, further comprising the step of:
commanding the output signal to a central value of an oscillation when the input control signal drops below the at least one maximum peak of the input control signal by a delta amount, wherein the central value of the oscillation is an average value of an oscillation of the input control signal.

3. The method of claim 2, further comprising the step of:
setting the output signal equal to the central value of the oscillation until the input control signal value becomes less than the central value of the oscillation.

4. The method of claim 3, further comprising the step of:
setting the output signal equal to the input control signal once the input control signal value becomes less than the central value of the oscillation.

5. The method of claim 1, further comprising the step of:
commanding the output signal to a central value of the oscillation when the input control signal value rises above the at least one minimum peak of the input control signal by a delta amount, wherein the central value of the oscillation is an average value of an oscillation of the input control signal.

6. The method of claim 5, further comprising the step of:
setting the output signal equal to the central value of the oscillation until the input control signal value becomes greater than the central value of the oscillation.

7. The method of claim 6, further comprising the step of:
setting the output signal equal to the input control signal once the input control signal becomes greater than the central value of the oscillation.

8. The method of claim 1, further comprising the step of:
setting the output signal equal to the input control signal if the input control signal value has not dropped a delta amount below the at least one maximum peak.

9. The method of claim 1, further comprising the step of:
setting the output signal equal to the input control signal if the input control signal value has not risen a delta amount above the at least one minimum peak.

10. The method of claim 1, further comprising the step of:
offsetting the output signal when at least one of the input control signal value drops a delta amount below the at least one maximum peak and a slope of the input control signal is negative until the input control signal both becomes less than a central value of the oscillation and the slope becomes positive, wherein the central value of the oscillation is an average value of an oscillation of the input control signal.

11. The method of claim 10, further comprising the step of:
setting the output signal equal to the input control signal once the input control signal value becomes less than the central value of the oscillation and the slope becomes positive.

12. The method of claim 1, further comprising the step of:
offsetting the output signal when at least one of the input control signal value rises a delta amount above the at least one minimum peak and a slope of the input control signal is positive until the input control signal becomes greater than a central value of the oscillation and the slope becomes negative, wherein the central value of the oscillation is an average value of an oscillation of the input control signal.

13. The method of claim 12, further comprising the step of:
setting the output signal equal to the input control signal once the input control signal value becomes greater than the central value of the oscillation and the slope becomes negative.

14. A control method for compensating for time delays in a control system comprising the step of:
providing an input control signal having a value that ranges between at least one maximum peak and at least one minimum peak, the input control signal being related to a corresponding oscillatory signal;
providing an output signal substantially similar to the input control signal to input into an actuator; commanding the output signal to a central value of the oscillation when the input control signal drops a delta amount below the at least one maximum peak; and
commanding the output signal to the central value of an oscillation when the input control signal amplitude rises a delta amount above the at least one minimum peak of the input control signal, wherein the central value of the oscillation is an average value of an oscillation of the input control signal.

15. The method of claim 14, wherein the step of commanding the output signal to the central value of the oscillation when the input control signal drops a delta amount below the at least one maximum peak further comprises the step of:
setting the output signal equal to the central value of the oscillation until the input control signal becomes less than the central value of the oscillation.

16. The method of claim 15, further comprising the steps of:
setting the output signal equal to the input control signal once the input control signal value becomes less than the central value of the oscillation.

17. The method of claim 14, wherein the step of commanding the output signal to the central value of the oscillation when the input control signal rises a delta amount above the at least one minimum peak of the input control signal further comprises the step of:
setting the output signal equal to the central value of the oscillation until the input control signal becomes greater than the central value of the oscillation.

18. The method of claim 17, further comprising the step of:
setting the output signal equal to the input control signal once the input control signal becomes greater than the central value of the oscillation.

19. The method of claim 14, further comprising the step of:
setting the output signal equal to the input control signal if the input control signal has not dropped a delta amount below the at least one maximum peak.

20. The method of claim 14, further comprising the step of:
setting the output signal equal to the input control signal if the input control signal has not risen a delta amount above the at least one minimum peak.

21. A method for compensating for time delays in oscillatory signals comprising the steps of:
providing an input control signal having a value that ranges between at least one maximum peak and at least one minimum peak, the input control signal being related to a corresponding oscillatory signal;
providing an output signal substantially similar to the input control signal to input into an actuator;
offsetting the output signal when at least one of the input control signal value drops a delta amount below the at least one positive maximum peak and a slope of the input control signal is negative or zero until the input control signal becomes less than a central value of an oscillation, wherein the central value of the oscillation is an average value of an oscillation of the input control signal; and
offsetting the output signal when at least one of the input control signal value rises a delta amount above the at least one minimum peak and a slope of the input control signal is positive or zero until the input control signal becomes greater than the central value of the oscillation and the slope becomes negative.

22. The method of claim 21, wherein the step of offsetting the output signal by an offset when at least one of the input control signal value drops a delta amount below the at least one maximum peak and a slope of the input control signal is negative or zero until the input control signal becomes less than the central value of the oscillation and the slope becomes positive further comprises the step of:
setting the output signal equal to the input control signal once the input control signal value becomes less than the central value of the oscillation and the slope becomes positive.

23. The method of claim 22, wherein the step of offsetting the output signal by an offset when at least one of the input control signal value rises a delta amount above the at least one minimum peak and a slope of the input control signal is positive until the input control signal becomes greater than the central value of the oscillation, further comprises the step of:
setting the output signal equal to the input control signal once the input control signal value becomes greater than the central value of the oscillation and the slope of the input signal becomes negative.

24. An oscillatory control system comprising:
an oscillatory signal-generating device;
a sensor that senses an oscillatory signal generated by the oscillatory signal-generating device, wherein the sensor transmits a sensed input control signal to a computational device;
a computational device capable of performing an oscillatory time-delay compensation algorithm used to generate an output signal in response to the sensed input control signal; and
an actuator actuated by an output signal, wherein the actuator operates in the oscillatory control system.
